(19) United States
(12) Patent Application Publication
(10) Pub. No.: US 2013/0258431 A1
(43) Pub. Date: Oct. 3, 2013

(54) INSTRUMENT CLUSTER FOR A MOTOR VEHICLE

(71) Applicants: Alain Guidi, Turckheim (FR); Claude Simon, Plobsheim (FR); Hassan Moussa, Illkirch (FR); Idriss El Hafidi, Illkirch-Graffenstaden (FR); Thibaud Barillot, Illkirch (FR)

(72) Inventors: Alain Guidi, Turckheim (FR); Claude Simon, Plobsheim (FR); Hassan Moussa, Illkirch (FR); Idriss El Hafidi, Illkirch-Graffenstaden (FR); Thibaud Barillot, Illkirch (FR)

(73) Assignees: UNIVERSITE DE STRASBOURG, STRASBOURG, FR (FR); DELPHI TECNOLOGIES, INC., TROY, MI (US)

(21) Appl. No.: 13/704,324

(22) PCT Filed: May 23, 2011
(86) PCT No.: PCT/EP11/58375

§ 371 Date: May 29, 2013

(30) Foreign Application Priority Data
Jun. 15, 2010 (FR) 1054719

(51) Int. Cl. G02B 27/01

(52) U.S. Cl. CPC G02B 27/0103
USPC 359/13

(57) ABSTRACT

An instrument cluster, in particular for a motor vehicle comprises a display screen to display information to the driver of the vehicle, a holographic memory containing the information stored in the form of holograms, and a light source to generate one or more reading light beams to extract the information to be displayed from the holographic memory and display the information extracted from the holographic memory on the display screen. A head-up display device is integrated in the instrument cluster and comprises a combiner that projects information extracted from the holographic memory into the head-up field of view of the driver.

### CROSS-REFERENCE TO RELATED APPLICATION

This application claims the benefit under 35 U.S.C. §371 of published PCT Patent Application Number PCT/EP 2011/058375, filed May 23, 2011, claiming priority to French patent application number FR1054719 filed on Jun. 15, 2010, and published as WO2011/157513 on Dec. 22, 2011, the entire contents of which is hereby incorporated by reference herein.

### TECHNICAL FIELD OF INVENTION

The present invention relates to an instrument cluster (dashboard) in particular for a motor vehicle, more particularly such a cluster restoring information to be displayed to the user (in particular the driver) from a holographic memory.

### BACKGROUND OF INVENTION

Instrument clusters for motor vehicles are today mainly based on combinations of mechanical systems (e.g. dials with motor-actuated needles or gauges), indicator lights, and fluorescent or liquid-crystal displays. An instrument cluster is typically used for the display of information relating to the operation of a motor vehicle such as, e.g. the speed of displacement, the number of revolutions of the engine, the fuel level of this vehicle, the number of kilometers travelled, as well as various alarms, warnings (oil-pressure, brake fluid level, vehicle door open, etc.) or operating signals (e.g. sidelights, dipped or full-beam headlights, hand-brake applied, etc.)

Certain cars are additionally fitted with a head-up display device permitting display of information superimposed on the exterior environment such as it appears from the viewpoint of the driver. A head-up display device typically includes a projection unit that produces a light beam intended to be directed towards a combiner in order to project an image, in particular containing information relating to the functioning or the driving of the vehicle, into the field of view of the driver in the form of a virtual image. Such devices were initially created on the basis of technologies derived from aeronautical applications. Their manufacturing costs were consequently often high, of a nature to prevent their marketing and their larger scale installation in low or medium range vehicles.

It should be noted that the head-up display devices known today are display units separate from the instrument cluster, although they are fitted in front of the driver in the front zone of the cars and therefore in the proximity of the instrument cluster. Consequently, the work (and therefore the costs) of fitting a head-up display device both in the design and in the production phase is relatively large.

An objective of the present invention is to be able to propose a head-up device requiring less fitting work than the head-up devices in accordance with the state of the art.

### SUMMARY OF THE INVENTION

The invention attains this objective firstly by the fact of proposing an instrument cluster with an integrated head-up display device as well as the fact of being based on optical diffraction techniques permitting generation of the information that can be displayed simultaneously on the instrument cluster and by the head-up display device. It will be appreciated that the association of the display on the instrument cluster and of the head-up display permits a better distribution, from the ergonomic point of view, of the information necessary to driving safety.

More particularly, an instrument cluster, in particular for a motor vehicle, in accordance with the invention, comprises a display screen (typically a translucent diffuser screen) to display information to the driver of the vehicle, a holographic memory containing the information stored in the form of holograms, and a light source to generate one or more reading light beams to extract the information to be displayed from the holographic memory and display the information extracted from the holographic memory on the display screen. The head-up display device, integrated in the instrument cluster, comprises a combiner that projects information extracted from the holographic memory into the head-up field of view of the driver. The reading beams therefore illuminate the zones of the memory containing the information to be displayed and restore it on the one hand on the display screen and on the other superimposed on the exterior environment such as it appears from the viewpoint of the user. The display screen is preferably designed with optical properties at the molecular level allowing orientation of the beam coming from the holographic memory with a defined angular magnitude and an optimized contrast.

The instrument cluster preferably includes a beam separator, for example a semi-reflective minor, arranged in the optical path between the holographic memory and the display screen to separate the light beam or beams generated by the light source into a first beam or a first group of light beams directed towards the display screen, and a second beam or a second group of beams directed towards the combiner of the head-up display device. The information to be displayed is therefore restored on the display screen by the first beam or the first group of light beams, and in the head-up field of view of the driver by the second beam or the second group of beams directed towards the combiner.

The beam separator preferably comprises a curved (e.g. parabolic) semi-reflective minor to adjust the divergence of the beam or beams directed towards the combiner of the head-up display device.

Advantageously, the holographic memory comprises a holographic storage support mounted movably in translation and/or in rotation on a frame and positioning means (e.g. one or more positioning motors and the mechanism related thereto) to bring the holographic storage support into and maintain it in a position selected depending on the information having to be displayed. The positioning means are preferably controlled by a control unit configured to receive as input the parameters of the vehicle (e.g. via the vehicle interface) to determine the information to be displayed to the driver on the basis of these parameters and to so control the positioning means that the zones of the holographic memory containing the information to be displayed are illuminated.

In accordance with an advantageous embodiment of the invention, the holographic memory comprises a plurality of holographic storage supports mounted movably in translation and/or in rotation on a frame and positioning means to bring the holographic storage supports, one independently of the other, into and maintain them in a respective position selected depending on the information having to be displayed. In this manner, the number of combinations of information able to be simultaneously displayed can be considerably increased.

The holographic storage support or supports are preferably in disc form, in particular mounted movably in rotation on the frame by means of a guiding system on the edge of the holographic storage support or supports in disc form. The central zone of the disc or discs is consequently available for the storage of information, contrarily to the case of discs lodged on a central spindle.

The holographic storage support or supports comprise a plate made of transparent plastics material, e.g. of polycarbonate (PC), of methyl polymethacrylate (PMMA), of polyethylene terephthalate (PET), on the surface of which is engraved the information to be displayed in the form of holograms. The main advantage of such storage supports is their low cost per unit, as they lend themselves to mass production by replication of a master. The different information intended to be displayed can be recorded either by laser interference lithography or by digital generation of holograms suited to the production of the master by micro-manufacturing technique.

In accordance with an advantageous embodiment of the invention, the combiner of the head-up display device is retractable into the instrument cluster. The user can thus choose whether he wishes to have the information displayed to him only on the instrument cluster or also via the head-up display device.

The combiner can be a semi-reflective minor or a diffractive combiner, i.e. comprising an optical diffraction grating, so arranged as to deviate the incident light into the field of view of the user.

In the case of a diffractive combiner, the head-up display device preferably comprises a reflecting diffuser support so arranged that the information extracted from the holographic memory is restored in the form of an object image and that a virtual image of this object image appears in the head-up field of view of the driver. In other words, the light beam or beams restore the information to be displayed on the diffuser support in the form of a real image of the previously recorded information. The combiner then deviates the diffuse light emanating from the diffuser support into the field of view of the user, thus creating the illusion that the diffuse light source is situated in the extension of the axis going from the eyes of the user to the combiner.

To produce a plurality of reading beams, a plurality of light sources and/or one or more beam separators arranged in the optical path between the light source and the holographic memory can be provided, to separate the light beam coming from the light source into a plurality of reading light beams.

The instrument cluster in accordance with the invention preferably comprises scanning means to displace in the holographic memory the spot or spots (illuminated points) produced by the reading light beam or beams, depending on the information having to be displayed. The scanning means are preferably controlled by a control unit that determines the position of the spots and therefore the information to be displayed. Where the scanning means are used in conjunction with means for positioning of the holographic memory, the two are preferably controlled by the control unit that then coordinates the different possible movements.

Further features and advantages will appear more clearly on a reading of the following detailed description of the preferred embodiment, which is given by way of non-limiting example only and with reference to the accompanying drawings.

### BRIEF DESCRIPTION OF DRAWINGS

Other features and characteristics of the invention will become apparent from the detailed description of some advantageous embodiments presented below, by way of illustration, with reference to the attached drawings.

FIG. 1 is an external view of an instrument cluster with an integrated head-up display device, in accordance with a preferred embodiment of the invention;

FIG. 2 is a partial exploded view of the instrument cluster of FIG. 1;

FIG. 3 is a three-dimensional view of the beam multiplier shown in FIG. 2;

FIG. 4 is a three-dimensional view of the holographic memory shown in FIG. 2;

FIG. 5 is a diagrammatic section showing the optical paths in the instrument cluster of FIG. 1;

FIG. 6 is a diagrammatic section showing the optical paths in an instrument cluster in accordance with an alternative embodiment of the instrument cluster of FIG. 1;

FIG. 7 is a diagrammatic representation of an arrangement for the recording of information in the form of holograms;

FIG. 8 is a diagrammatic frontal view of a holographic storage disc;

FIG. 9 is an external view of an instrument cluster with integrated head-up display device in accordance with another preferred embodiment of the invention;

FIG. 10 is an illustration of a first alternative embodiment of the instrument cluster of FIG. 9; and

FIG. 11 is an illustration of a second alternative embodiment of the instrument cluster of FIG. 9.

### DETAILED DESCRIPTION

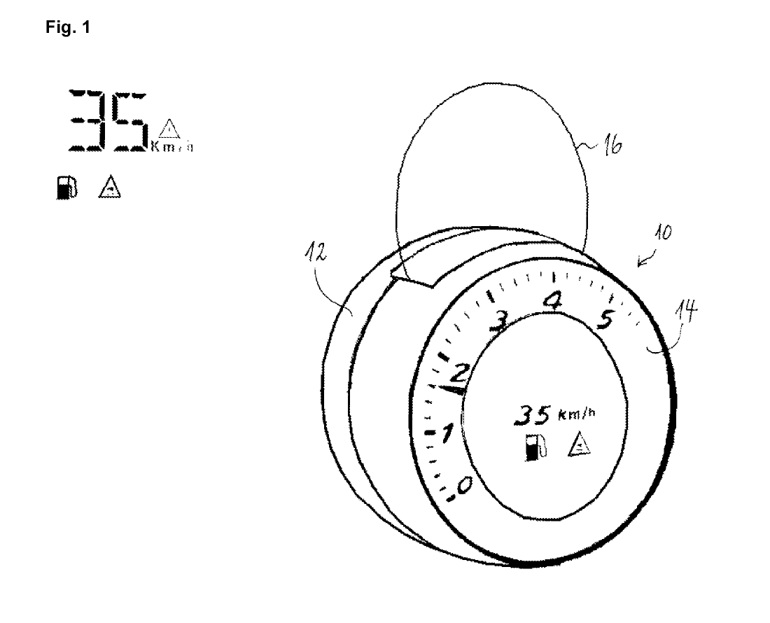

FIG. 1 shows the external appearance of an instrument cluster 10 with an integrated head-up display device for a motor vehicle. The instrument cluster 10 comprises a case 12, of generally cylindrical form, in which are integrated the different elements permitting the display of information relating to the operation of a motor vehicle. On the side intended to face the driver, the instrument cluster 10 comprises a display screen 14 made of translucent, light-diffusing material onto which is projected the information to be displayed. The instrument cluster 10 also permits display of the information superimposed on the exterior environment by the head-up display device. The information intended for the head-up display appears in the extension of the axis going from the eyes of the driver to the combiner 16 of the integrated head-up display device, creating the illusion for the driver that this information is displayed forward of the windscreen, as a certain distance (e.g. between 1 and 5 m) from the eyes of the driver.

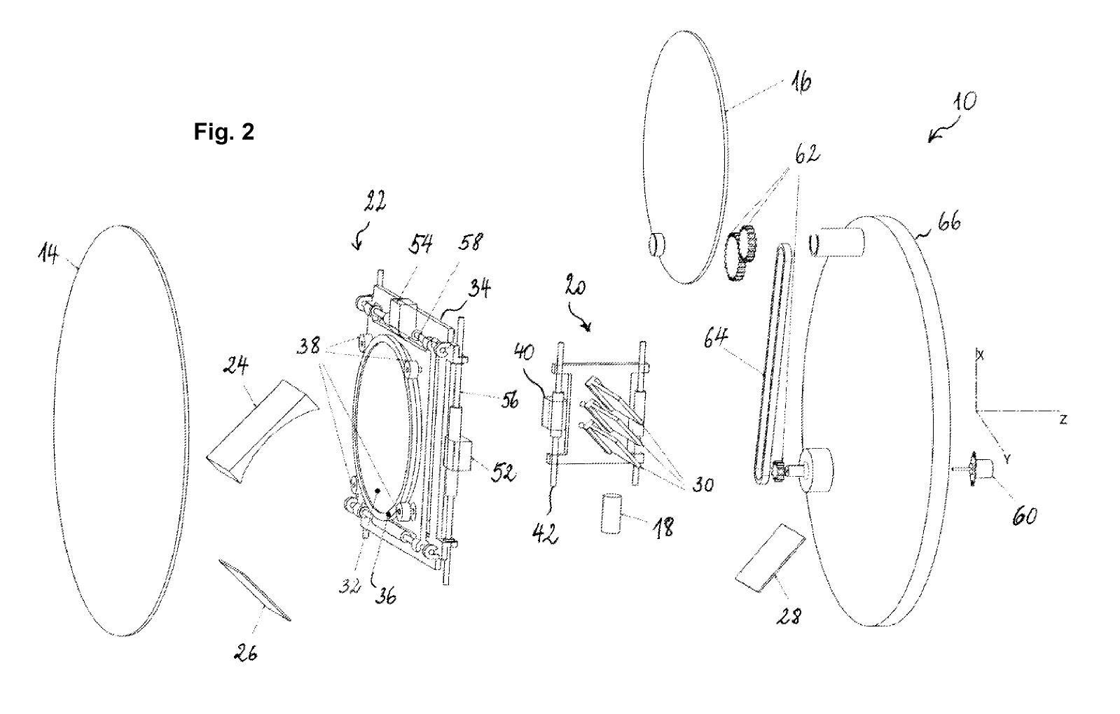

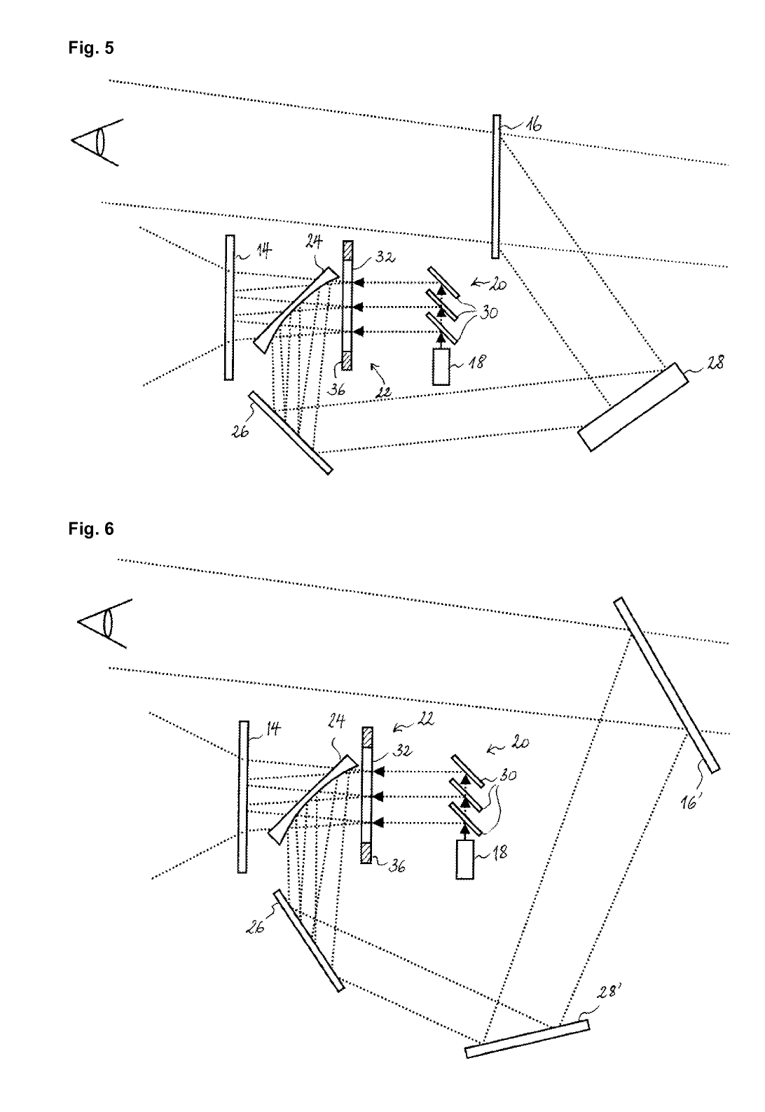

FIG. 2 shows a partial exploded view of the instrument cluster of FIG. 1. FIG. 5 shows a diagrammatic longitudinal section through the system of FIG. 2. In addition to the display screen 14 and the combiner 16, the optical system comprises a light source 18 (e.g. a laser), a light beam multiplier 20, a holographic memory 22, a beam separator 24, a deviation minor 26 and a diffuser support 28.

The light source 18 produces a light beam that is separated into a plurality of reading beams by the light beam multiplier 20. This comprises a set of n minors 30 of different reflectivities (in the example shown, n=3), so designed that the divided beams are of power at least approximately equal to P/n where P designates the optical power of the source. In the example of FIG. 2, the first and the second mirror 30 on the optical path are semi-reflective mirrors of a reflectivity of 33% and of 50%, respectively. The third minor 30 is a minor of close to 100% reflectivity. The beam multiplier 20 therefore sends n reading beams back towards different zones of the memory 22 and/or at different angles to read the information stored in the form of holograms.

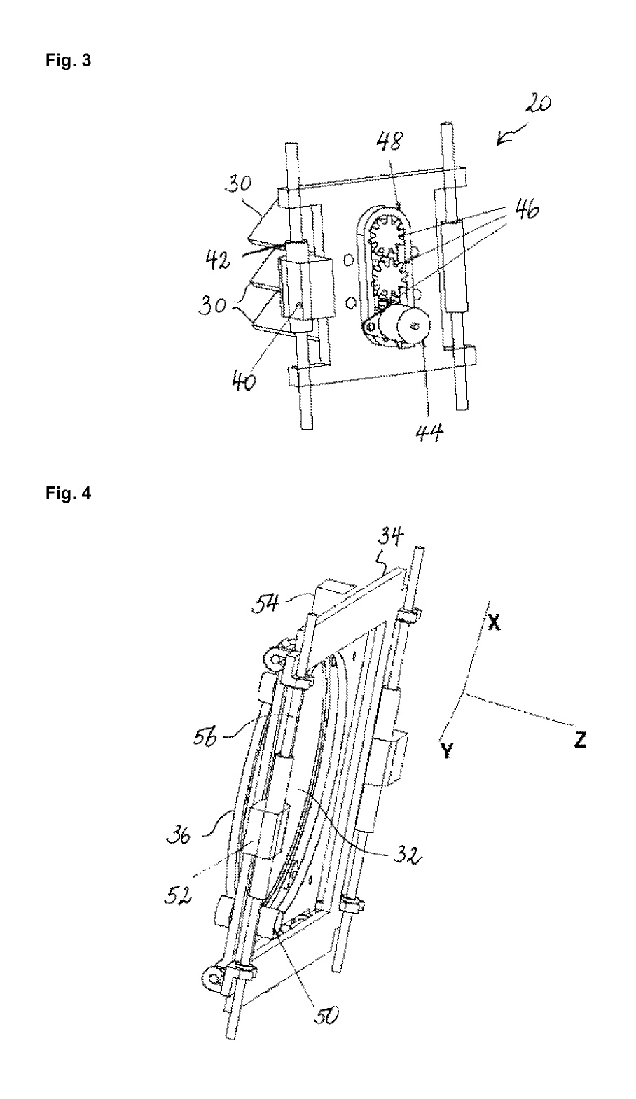

FIG. 3 shows the rear side of the beam multiplier 20. The mirrors 30 are mounted movably in rotation and in translation by means of a positioning system. The positioning system and the minors together form a scanning system to displace in the holographic memory 22 the spot or spots produced by the n reading light beams. The set of minors 30 is carried on a support plate, which a motor 40 allows to be driven in rotation by means of a worm 42. The minors 30 are driven in rotation by an assembly of another motor 44, of toothed wheels 46 and a belt 48. Each mirror 30 can thus be made to turn about a respective axis substantially perpendicular to the plane containing the incident beam (coming from the light source 18) and the reading beams. The positioning system of the beam multiplier 20 thus permits variation of the angle of incidence and the position of the reading beams on the holographic storage disc 32 of the memory 22, and consequently, variation of the information extracted depending on the angle of incidence and on the positions of the spots. The positioning system of the beam multiplier 20 shown in FIGS. 1 and 3 preserves the angles between the minors 30 and does not therefore allow control of the angle of incidence of the n light beams in individual manner. Should it be required to do this, an individual positioning system should be provided for each mirror 30.

As shown in FIGS. 2 and 4, the holographic memory 22 comprises a holographic storage disc 32 (e.g. made of polycarbonate, of PMMA or of PET) mounted movably in translation and in rotation on a frame 34, and a mechanical positioning system to bring the disc 32 into and keep it in a position selected depending on the information having to be displayed. The mechanical positioning system comprises a toothed rim 36 fixed to the edge of the disc 32 and driven by gear-wheels 38 coupled to a motor 50 which allows a rotational movement of the disc 32 to be obtained. The selected configuration allows the use of the whole of the surface of the disc 32 to store the necessary information as the rotational guiding is performed on the outer edge of the disc contrarily to the systems that are driven in rotation by a motor on their axis of rotation. For more optimized reading of the information encoded on the disc 32, the movement in rotation is coupled with two movements of translation along the axes x and y. The combination of a rotation with two translations allows the whole of the surface of the disc 32 to be covered in optimal manner. Each translation is performed by a motor 52, 54 respectively, which drives a worm 56, 58 respectively.

The positioning means both of the beam multiplier 20 and of the holographic memory are controlled by a control unit (not shown) which as input receives the parameters of the vehicle (e.g. speed, fuel level, etc.), deduces from them the information (stored images) to be displayed to the driver so that the zones of the holographic memory containing the information to be displayed are each illuminated at an appropriate angle of incidence.

On reading from a holographic memory, the illumination by the reading beam is performed at the angle of the “reference” beam at recording. This leads to a diffraction of the light that reconstructs the “object” beam. After diffraction in the holographic storage disc 32, the reading beams are “printed” with the information to be displayed. The recording parameters of the information to be displayed are so selected that the stored images are reconstructed as real images on the display screen 14.

After passage through the holographic storage disc 32, the beam separator 24 divides the reading beams into a first group of transmitted beams striking the display screen 14, and a second group of beams reflected towards the head-up display device. The beam separator is produced in the form of a parabolic semi-reflective minor (e.g. of 50% reflectivity) in order to adjust the divergence of the reflected beams and to minimize size. The deviation minor 26 deviates the reflected beams towards the diffuser support 28 where another real image of the stored information is reconstructed.

The diffuse light produced on the diffuser support 18 is deviated towards the driver by the diffractive combiner 16 (which is e.g. made of polycarbonate, of PMMA or of PET), when this is deployed. Preferably, the optical diffraction grating of the diffractive combiner 16 also performs a function of enlargement (so as to adjust the size of the virtual image which is presented to the driver) and of positioning of the virtual image in the field of view of the driver while respecting the real scene.

The combiner 16 is retractable into the case 12 by a mechanism comprising a motor 60 that drives a gear train 62 and a toothed belt 64. These elements are held on the rear plate 66 of the case 12. The combiner is housed to be able to turn about an eccentric axis, which allows it to be made to exit or re-enter depending on the operating mode selected by the driver (i.e. with or without head-up display). It will be appreciated that other means can be employed to make the combiner 16 exit or re-enter. For example, instead of using a system driving the eccentric rotation of the combiner, a system could also be provided configured to cause the combiner to exit and re-enter by a movement of translation.

FIG. 6 shows a view in longitudinal section through an alternative embodiment of the system of FIG. 2. The instrument cluster of FIG. 6 is distinguished from that shown in FIGS. 2 and 5 by the fact that the diffuser support 28 is replaced by a deviation minor 28′ and that a reflective combiner 16′ is used instead of the diffractive combiner 16. In the case of FIG. 6, the reflective combiner 16′ is a flat semi-reflective minor (about 60% reflectivity). A curved semi-reflective mirror could however be used, in particular to adjust the size of the virtual image displayed to the driver and the distance at which the virtual image is situated.

The holographic storage disc 32 can store information in the form of holograms of images comprising the information. A frontal diagram of the holographic storage disc 32 is shown in FIG. 8. The holograms 68 are arranged in a plurality of concentric circles. The memory zones cover almost the whole of the surface of the disc 32. The mechanical driving of the disc has been designed so as to be able to use the whole of this surface for the storage of information. All the information able to be displayed is pre-recorded on the disc 32 and read depending on the parameters of the vehicle or of other circumstances requiring the display of certain information to the driver. Each image is recorded taking into account: its position on the disc; the orientation of the disc at the moment of reading and of display of the image; the direction of incidence of the reading beam; the wavelength of the reading beam; the required direction of the diffracted beam (and therefore the position of the image on the display means); the required divergences of the diffracted beam; etc.

It will be noted that different holograms can be superimposed in a same zone of the holographic memory (multiplexed holograms), provided these holograms correspond to different directions of incidence of the reading beam or beams. Thus, in a given memory zone, each angle of incidence corresponds to a piece of display information. The multiplexing of holograms allows storage of a maximum of information.

The processes envisaged for producing the holographic storage disc comprise digital holography and analogue holography.

In a digital holography process, the diffractive structure, i.e. the hologram, is calculated by computer depending on the image to be displayed, the reading parameters (e.g. wavelength of the reading beam, angle of incidence, size of the spot produced by the reading beam, etc.) and the display parameters (e.g. position and size of the image on the display means, etc.). The calculation is performed for example on the basis of iterative methods, of FDTD (from the English: Finite Difference Time Domain—fine differences in the time domain), EMT (from the English: Effective Medium Theory—theory of the effective media) or others. A digital model of the diffractive structure is finally obtained, which is then written by micro-manufacturing techniques. Preferably, a master of the holographic storage disc is firstly created by photolithography or by electron beam lithography, from which master copies are then made by a mass production process. The master is for example made of a material such as silicon or quartz and is then used to produce the mold used for plastics replication.

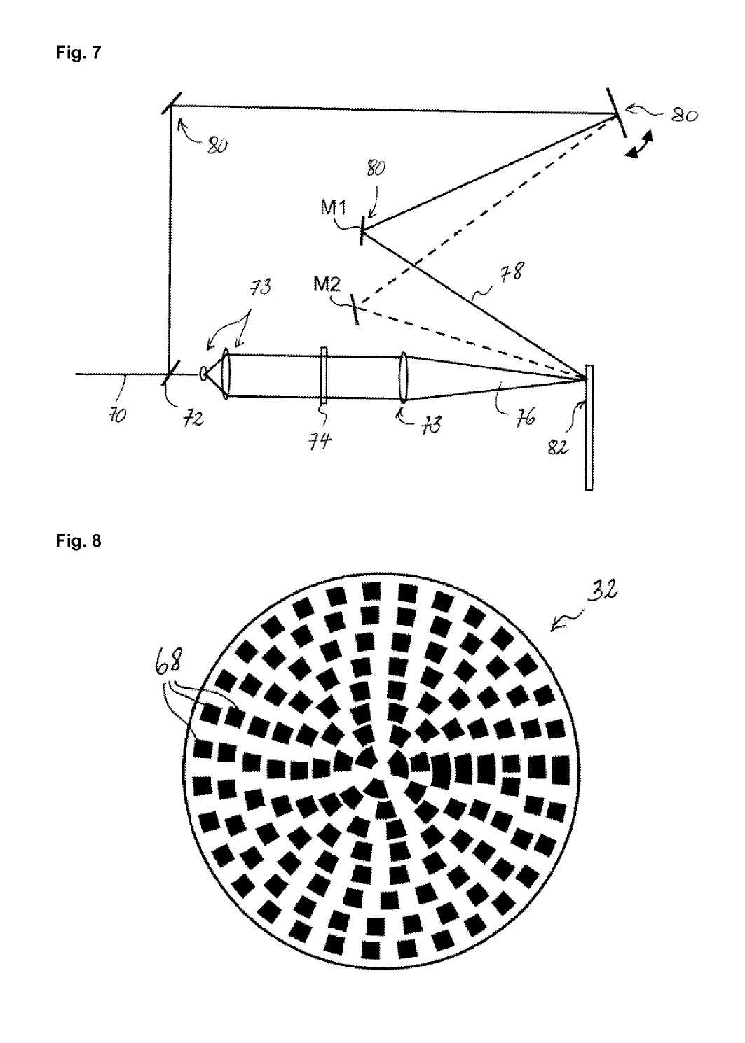

If laser interference lithography is selected to produce the holographic memory, FIG. 7 is preferably followed. A laser beam 70 is separated into two by a beam separator 72 (e.g. a semi-reflective mirror). One of the beams thus obtained is expanded, and then collimated by an assembly of lenses 73. The collimated beam illuminates a transmissive liquid crystal screen 74 by means of which the image to be recorded is “loaded” in the beam (giving the object beam 76). The position of the image and its size are digitally selected and the liquid crystal screen 74 is controlled as a consequence. The object beam 76 then passes through a convergent lens to adjust the size of the hologram (which can be less than 1 mm²). The other beam (reference beam 78) is directed towards a plurality of mirrors 80 to superimpose it on the object beam 76 in a layer of photosensitive resin 82 spread on a hard support (e.g. a glass plate). The interference of the object 76 and reference 78 beams gives the hologram which is recorded in the photosensitive layer 82.

The whole of the recording of FIG. 7 is specially designed to record a plurality of holograms in consecutive manner. The system permits direction of the reference beam onto the photosensitive layer in different directions of incidence. A plurality of holograms can thus be multiplexed in the same zone of the photosensitive layer 82. On reading, the different pieces of information are individually extracted using a reading beam meeting the holographic storage disc at the same angle of incidence as that which was used on recording. FIG. 7 shows that the reference beam 78 is firstly reflected by a minor movable in rotation, which directs it either towards the minor M1, or towards the minor M2. A first hologram is recorded by causing the reference beam 78 to pass onto the mirror M1. Then, the image produced on the liquid crystal screen 74 is changed and another hologram is recorded by causing the reference beam 78 to pass onto the minor M2, without moving the plate carrying the photosensitive layer 82. This procedure can be repeated for other angles of incidence of the reference beam 78. The number of holograms that can be multiplexed in the same place in the photosensitive layer 82 depends on the saturation of the photosensitive medium.

The plate carrying the photosensitive layer 82 is preferably mounted movably in rotation (about an axis perpendicular to the photosensitive layer) and/or in translation (in the plane of the photosensitive layer) to allow the recording of holograms over the whole surface of the photosensitive layer.

The object 76 and reference 78 beams produce interference fringes in the layer of photosensitive resin 82 that causes modulation in space of the solubility of the resin. The exposed zones of the photosensitive resin thus become more or less soluble relative to the other zones. Chemical engraving then permits removal of the unexposed zones (or exposed zones depending on the type of the photosensitive resin: negative or positive) so as to obtain a surface diffractive structure. The diffractive structure in relief is then transferred to a mold for mass replication of copies made of synthetic material (e.g. of polycarbonate, of PMMA or of PVB) of the recorded holograms.

On reading, the reading beam is directed onto a disc zone containing the hologram recorded at an angle a with the normal to the disc. The restored image will then be the one that has been recorded in this zone with the angle a. The direction of diffraction corresponds to the direction of the object beam. The divergence of the diffracted beam containing the image to be displayed is determined by the choice of the focal length of the convergence lens used for the reduction of the section of the object beam.

To increase the density of the information stored in the holographic memory, it is possible to superimpose a plurality of holographic storage discs. These discs can be attached one to the other (e.g. stuck together) or movable one relative to the other. In the first case, a single rotation and/or translation system can be used for all of the discs. In the other case, separate rotation and/or translation mechanisms are necessary for the discs. The advantage of having a plurality of independent discs is the increased flexibility relative to the combinations of information able to be displayed.

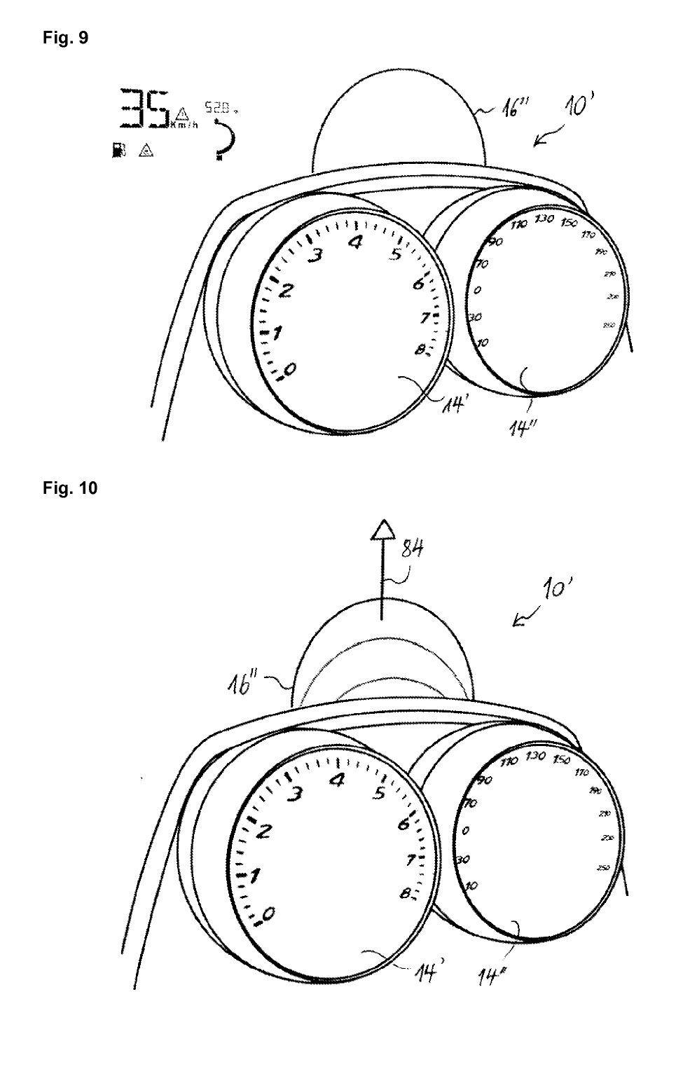

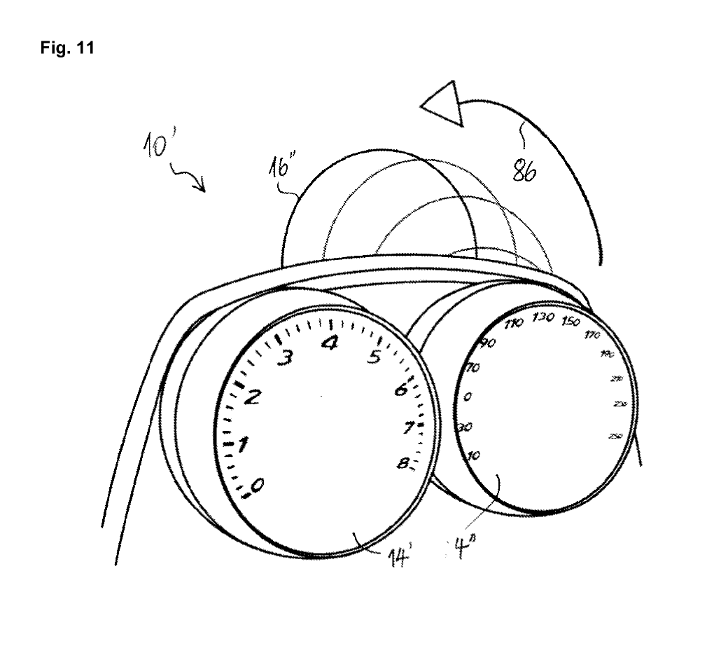

An instrument cluster in accordance with another preferred embodiment of the invention is shown in FIGS. 9 to 11. The instrument cluster 10′ comprises two display screens 14′ and 14″ and an integrated head-up display device. The combiner 16″ of the instrument cluster 10′ is made retractable. In accordance with the alternative embodiment of FIG. 10, the combiner 16″ performs a movement of translation (indicated by the arrow 84) to enter or leave the case of the instrument cluster 10′. In accordance with the alternative embodiment of FIG. 10, the combiner 16″ performs a movement of rotation (indicated by the arrow 86) to enter or leave the case of the instrument cluster 10′.

Other alternative embodiments of retraction mechanisms are possible within the context of the invention. For example, the combiners 16, 16′ 16″ could be made to exit or re-enter by a combined movement of rotation and translation, and/or by causing them to tip towards the front or the rear.

While this invention has been described in terms of the preferred embodiments thereof, it is not intended to be so limited, but rather only to the extent set forth in the claims that follow.

1. An instrument cluster for motor vehicle, said instrument cluster comprising:
a display screen to display information to the driver of the vehicle;
a holographic memory containing the information stored in the form of holograms;
a light source to generate one or more reading light beams to extract information to be displayed from the holographic memory, and display the information extracted from the holographic memory on the display screen;
a head-up display device, integrated in the instrument cluster, the said head-up display device comprising a combiner to project the information extracted from the holographic memory into the head-up field of view of the driver.

2. The instrument cluster as described in claim 1, wherein said instrument cluster further comprises a beam separator arranged in the optical path between the holographic memory and the display screen to separate the light beam or beams generated by the light source into a first beam or a first group of light beams directed towards the display screen and a second beam or a second group of beams directed towards the combiner of the head-up display device.

3. The instrument cluster as described in claim 2, wherein the beam separator comprises a semi-reflective curved mirror to adjust the divergence of the beam or beams directed towards the combiner of the head-up display device.

4. The instrument cluster as described in claim 1, wherein the holographic memory comprises a holographic storage support mounted movably on a frame, and a positioning means to bring the holographic storage support into and maintain it in a position selected depending on the information having to be displayed.

5. The instrument cluster as described in claim 1, wherein the holographic memory comprises a plurality of holographic storage supports mounted movably on a frame, and a positioning means to bring, one independently of the other, the holographic storage supports into and maintain them in a respective position selected depending on the information having to be displayed.

6. The instrument cluster as described in claim 4, wherein the holographic storage support or supports are in disc form.

7. The instrument cluster as described in claim 6, wherein the holographic storage support or supports are mounted movably in rotation on the said frame by means of a guiding system on the edge of the holographic storage support or supports in disc form.

8. The instrument cluster as described in claim 4, wherein the holographic storage support or supports comprise a plate made of transparent plastics material on the surface of which is engraved the information to be displayed in the form of holograms.

9. The instrument cluster as described in claim 1, wherein the combiner of the head-up display device is retractable into the instrument cluster.

10. The instrument cluster as described in claim 1, wherein the combiner is a diffractive combiner.

11. The instrument cluster as described in claim 10, wherein the head-up display device comprises a diffuser support so arranged that the information extracted from the holographic memory is restored in object image form on the diffuser support and a virtual image of this object image appears in the head-up field of view of the driver.

12. The instrument cluster as described in claim 1, wherein the combiner comprises a semi-reflective minor.

13. The instrument cluster as described in claim 1, wherein the instrument cluster further comprises one or more beam separators arranged in the optical path between the light source and the holographic memory, to separate a light beam coming from the light source into a plurality of reading light beams.

14. The instrument cluster as described in claim 1, wherein the instrument cluster further comprises a scanning means to displace the spot or spots produced by the reading light beam or beams in the holographic memory depending on the information having to be displayed.
